(19) United States
(12) Patent Application Publication
(10) Pub. No.: US 2008/0232891 A1
(43) Pub. Date: Sep. 25, 2008

(54) Input Device

(75) Inventors: Nuala Macklin, Dublin (IE); Damian Gerard Costello, Dublin (IE)

Correspondence Address: OSTROLENK FABER GERB & SOFFEN, 1180 AVENUE OF THE AMERICAS, NEW YORK, NY, 100368403, US

(73) Assignee: AUTOLIV DEVELOPMENT AB, Vargarda (SE)

(21) Appl. No.: 10/586,025

(22) PCT Filed: Jan. 13, 2005
(86) PCT No.: PCT/IE2005/000001

§ 371 Date: Jul. 13, 2006

(30) Foreign Application Priority Data
Jan. 13, 2004 (IE) S2004/0014

(51) Int. Cl. B41J 5/00

(52) U.S. Cl. 400/489

(57) ABSTRACT

An input device including a keypad, the keypad comprising wrist support means and curved key area. The wrist support means of each keypad comprises a generally flat portion having a plurality of soft cushioned pads protruding from the upper surface of the flat portion. The key area is contiguous to the wrist support means such that the key area has a negative convex curve. Thus in use a portion of the key area remote the wrist support means is positioned at a lower spatial position than the portion of the key area contiguous with the wrist support means. The key area has a plurality of keys positioned on the upper surface. The keys are arranged in a series of curved rows so that a central key in each row is further from the users wrist relative to at least one of the end keys in each row.

This invention relates to an input device such as a computer keyboard and in particular to an ergonomically designed computer keyboard.

Repetitive stress injuries (RSI), such as carpel tunnel syndrome are commonly found amongst people who are frequent users of standard keyboards, especially typists and/or computer programmers. Work related Neck and Upper Limb Disorders (WRNULD) are also commonly found amongst the same group of people. Generally cumulative overloading of the musculoskeletal system together with nerve irritation causes both of these complaints. The meridian nerve, one of the major nerves of the arm and hand is housed in the carpel tunnel. It is irritation of this nerve, and inflammation of the tunnel that gives rise to carpel tunnel syndrome.

Research has demonstrated that people who have intensively used conventional keyboards and a group of patients suffering from RSI display the same changed sensitivity to vibration stimulation (Greening J B, Lynn B, Int Arch Occup Health Environ Med, 1998). Further use of conventional keyboards by the RSI sufferers indicated that the RSI sufferers experienced even further reduced vibration sensitivity. Other research indicates that very minor manipulation of peripheral nerves can result in very painful symptoms (Eliave E, Neuroscience Abstracts, 62: 865, 1996; Bennet G J, Xie YK, Pain, 33:87, 1988). In RSI these symptoms include tingling and numbness in the fingers which progress to aching or shooting pains and weakness in the hands and forearm.

It is believed that nerve irritation and compression in people who intensively use keyboards occur at multiple sites due to the sustained maintenance of fingers, hands, wrists, arms, elbow joints and shoulder girdles in an unnatural position. It is further believed that this in particular effects the major nerve in the hand, the median nerve.

RSI and WRNULD is of major concern to such groups as these injuries lead to discomfort, lack of productivity and in some cases large quantities of compensation to employee's. Therapists and surgeons recommend that in order to reduce the potential for nerve irritation at the wrist and elbow, thus reducing the onset of RSI and WRNULD a keyboard operator should be able to assume a mid-range joint position at the elbow, superior and inferior radio-ulnar and wrist joints. Furthermore provision of support to the wrist area will reduce pressure on the carpal tunnel area.

Conventional keyboards are flat with an overall rectangular structure. Generally, the keys of the keyboard are arranged in a series of rows positioned along the long length of the rectangular keyboard. Conventionally the keys that are letters on the keyboard are positioned in a central group comprising a plurality of rows. Other keys such as function keys, cursor controls, numerical keys and so forth are positioned around this central group of keys. The flat design of the keyboard coupled with the position of the letter keys on the keyboard cause the neck joint, shoulder girdle, elbow joints, arms, wrists and hands to adopt an unnatural position when using the keyboard.

The user's head is angled to enable a user to either look at the screen or the document being typed therefore causing the neck joint to curve and strain. The shoulder girdle and arms are raised to allow the arms and wrists work in parallel on the central area of the keyboard. This coupled with the strained neck joint also causes the shoulders to curve. This in turn causes the upper body of the user to adopt an overall strained position. The elbow joint adopts an angle of less than 90°, putting strain on the elbow joint. Under normal relaxed conditions an elbow joint generally has an angle of greater than 90°. The users wrists and hands are arched above the keys on the keyboard, this causes the wrist joint to bend upwards against the natural direction of bend in the wrist. This causes strain and compression on the muscles of the wrist, which in turn exerts extra pressure on the nerves and tendons within the wrist giving rise to the symptoms associated with RSI and WRNULD.

There have been numerous attempts in the prior art to provide an ergonomic keyboard that prevents the above.

WO 97 36750 discloses an adjustable curved keyboard having arcuately arranged keys to complement naturally a user's wrist, hand and fingers. Despite this the user's wrists and arms must work in parallel on a group of central keys positioned in rows on the keyboard thereby causing the shoulder girdle to rise and curve providing poor posture and repetitive static activity of the neck and shoulder girdle.

JP 2002 14891 discloses a computer keyboard that comprises right and left hand side key groups which are convex shaped such that the central portion is higher than the front and back portions respectively. Despite the fact that the keys are split from a central group to two distinct key groups the user must still adopt the poor posture synonymous with conventional keyboards to operate this system. Furthermore there is greater pressure placed on the wrist when using this keyboard over conventional keyboards. This is because the rest position for the wrist is considerably lower than that of the high central portion. Also the keys within each key group are still arranged in rows causing the users wrist and fingers to bend in the same manner as if using a conventional keyboard especially when using the keys on the rows that are intermediate the high central portion and the wrist position.

U.S. Pat. No. 6,132,118 discloses a curved mound ergonomic keyboard that is complex and not easy to use. The keys of the keyboard are positioned on the sides and back of the keyboard and cannot be easily looked at by a user when in use. The keyboard can be used on either a desk or when being held on a users lap, however no support is provided with this keyboard. Therefore in order to avoid straining a users neck, and shoulder girdle, a user must hold this keyboard on their lap, which in turn is cumbersome and provides difficulties when operating the keys.

It is the object of the present invention to alleviate the above disadvantages.

Accordingly, the present invention provides an input device including a keypad, the keypad comprising wrist support means and key area, wherein the wrist support means of each keypad comprises a generally flat portion having a front and back portion and an upper and lower surface, the back portion being defined as the area of the wrist support means that is closest to a user's arm when in use and the front portion being defined as the area furthest from a user's arm when in use, wherein the wrist support means has a plurality of soft cushioned pads protruding from the upper surface of the flat portion, the key area comprises a curved unit having a front and back portion and an upper and lower surface, the back portion being defined as the area of the key area that is closest to a user's arm when in use and the front portion being defined as the area furthest from a user's arm when in use, wherein the back portion of the key area is contiguous to the front portion of the wrist support means, the key area having a negative convex curve, so that in use the upper surface of the front portion of the key area is positioned at a lower spatial position than the upper surface of the back portion of the key area, the key area having a plurality of keys positioned on the upper surface of the key area intermediate the front and back portions, and wherein the keys of the key area are arranged in a series of curved rows that are parallel to or concentric with the front and back portions of the key area, so that a central key in each row is further from the users wrist relative to at least one of the end keys in each row.

Advantageously the present invention further provides a wrist support means comprising a plurality of soft cushioned pads arranged in a generally square configuration where the square configuration is orientated such that in use one or more pads provide support for the thumb joint of the hand and a plurality of pads provide stabilisation for hand and wrist movement.

Preferably, the soft cushioned pads of the wrist support means comprise a plurality of gel filled pads.

It is preferable for three similar gel filled pads to stabilise the wrist. Ideally these pads occupy three adjacent corners of the overall square shape. Preferably a further gel filled pad is used to take the weight of the hand and support the thumb joint. Ideally this pad occupies the fourth corner of the square shape. Advantageously the overall square configuration is orientated such that in use the support for the thumb joint is positioned under the thenar eminence of the hand, the hand stabiliser is positioned under the hypothenar eminence and the wrist stabilisers are positioned under the wrist such that the wrist joint is intermediate the thumb support and the wrist stabilisers. Ideally this arrangement provides stability of the hand and wrist for the user in relation to the keyboard, aligning the wrist and preventing the wrist from twisting thereby preventing manipulation of the meridian nerve. Advantageously this arrangement does not impede or put any direct pressure on the carpel tunnel hence the meridian nerve of the wrist and hand.

Advantageously the plurality of gel filled pads can be formed in a single moulding, where the moulding maintains the individual contact points for the user's wrist and/or hand and/or thumb when in use. Ideally the single moulding is a soft contoured moulding. Optionally the gel filled pads can provide a source of heat for the user's wrist thereby warming the tendons of the wrist and hand. This warming action increases the blood supply, lymph fluid drainage and in general improves the overall molecular biology of the tissues in the wrist area which further helps prevent irritation to the meridian nerve thus reducing RSI. Advantageously the cushioned support is not limited to gel filled pads any suitable material, known to a person skilled in the art can be used, for example microcellular foam.

Advantageously the keypad has a support means attached to the lower side, which allows a user to manipulate the keypads in all directions to find the most comfortable position for the user to use the keypad. Ideally the user can directly manipulate the keypad by applying slightly greater hand force to the keypad than when actually using the keypad. It is preferable for the keypad to resist this action thus when the user finds his/her comfortable position the keypad easily maintains the desired position. Alternatively the support means can be manipulated and locked into a desired position.

Advantageously the keypad is operated by allowing a user's hand to curve naturally over the convex surface of the keypad, whereby the fingers easily find and manipulate the keys as required.

Advantageously the support means are not limited in size and can be adjusted to in height to provide support to the keypad if the user wishes to stand up or sit down. Alternatively the support means may also attach to securing means such as clamps to secure the keypad to an article of furniture such as a computer table or a chair or a wall.

The ability of the keyboard to rotate, in conjunction with the ability to adjust the height of the support means and the convex surface of the keypad allows the user to assume the correct neck, shoulder girdle, mid-range joint positions at the elbow, superior and inferior radio-ulner and wrist joints, reducing the potential for nerve irritation at the wrist and elbow. Advantageously a user is able to operate the keypad either standing, sitting or lying down.

Advantageously, the keys on the keypad are positioned in a series of curved rows, where the curve of each row follows the natural contour of the metacarpal phalangial joints of the hand. The metacarpal phalangial joints are more commonly known as the knuckle joints. The keys of the keypad therefore adopt an overall fan effect, enabling a user's hand to curve naturally over the keys, whereby the fingers can easily find and manipulate the keys as required. Advantageously the keys positioned at the end of each row that are commonly operated by the ring and little fingers are slightly raised to enable a user to access these keys with greater ease. This arrangement prevents lateral deviation of the wrist thereby reducing stress on the meridian nerve.

Advantageously in the preferred embodiment of the invention the input device comprises two keypads, where a first keypad is a left-hand keypad and a second keypad is a right-hand keypad. Ideally the keys of each keypad are arranged using the QWERTY keyboard layout, where the alphanumeric keys of the keypad are split into left and right hand keypads along the natural split line of the QWERTY keyboard. Ideally functional keys and control keys are divided between the two keypads as desired. Advantageously the keypad is not limited to this arrangement, other key arrangements such as the DVORAK arrangement can also be used. Alternatively a single keypad can be used where the keys of the keypad have dual functionality. For example a key normally used to form the letter C on a conventional keyboard, could also be used to form the letter N.

In a further embodiment of the invention the input device may be adapted for use with specialist applications, for example a computer programmer may have a keypad with specific commonly used programming command key in addition to alphanumeric keys. Alternatively the keypad may be adapted for use with computer games. In yet another embodiment of the invention the keypad may be adapted for use in specialist medical applications, for example where a user has limited and or restricted movement of the hand and fingers.

Advantageously the keypad has an optional pointing device such as a roller ball feature which functions as a mouse. Preferably a user can optionally change the position of the pointing device between a left-hand and right-hand keypad as desired. Alternatively a pointing device can be positioned on both keypads.

Advantageously the keypad has wireless functionality. Ideally in the preferred embodiment, where there are two keypads, each keypad has an individual transmitter and receiver unit. Preferably each transmitter unit independently transmits signals to the appropriate receiver unit. Advantageously the signal from each receiver unit is transmitted to the central processing unit (CPU) of the computer. Advantageously, where there are a plurality of keypads, the keypads are not limited to this arrangement, the signals from each keypad may be combined at any stage, for example one of the keypads may only communicate with a second keypad, thereby transmitting a signal to the second keypad, where the signal is combined with the signal of the second keypad and the combined signal is transmitted to the CPU. Advantageously the keypads are not limited to a wireless functionality, any suitable functionality known to a person skilled in the art can be used. Ideally, the keypad can also provide its own power if required, this can be done using batteries such as solar energy batteries.

It is preferred that the materials used to build each keypad are as environmentally friendly as possible, for example recycled plastics could be used to form the mouldings. The invention is not limited to these materials, as any material that is known to those skilled in the art can be used

The invention will hereinafter be described with reference to the accompanying drawings, which illustrate by way of example only, a computer keyboard according to the invention.

In the drawings:—

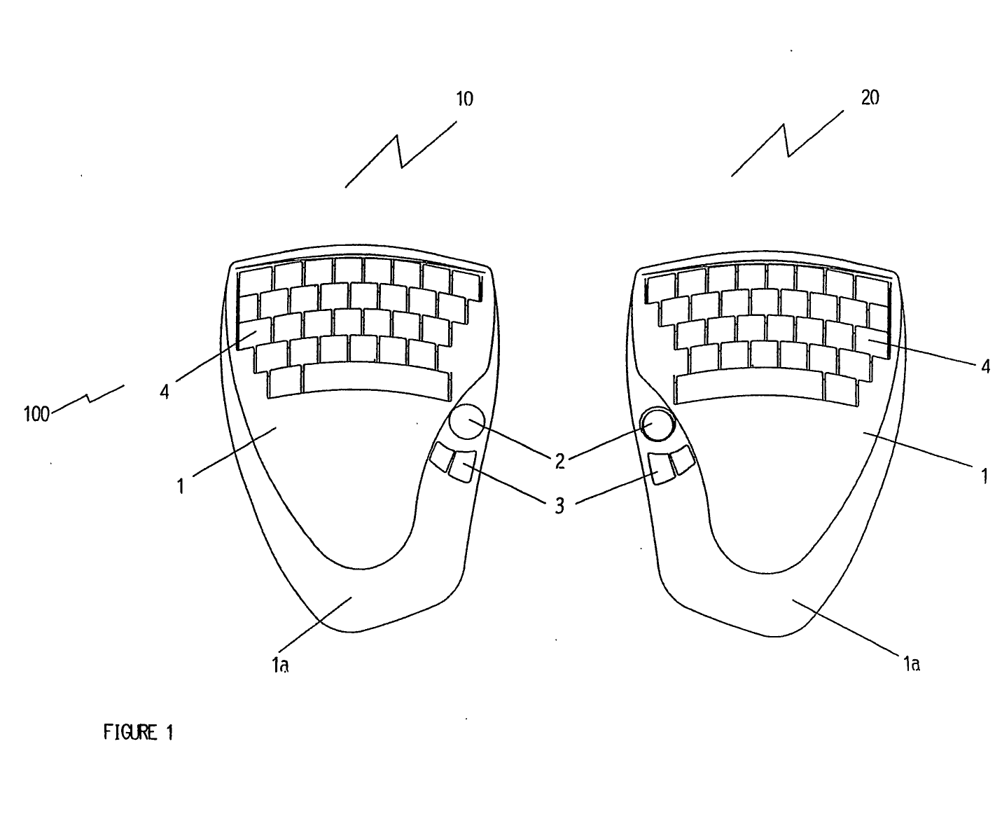

FIG. 1 is a plan view of a right and left keypad (without cushioned support) of the computer keyboard according to the invention;

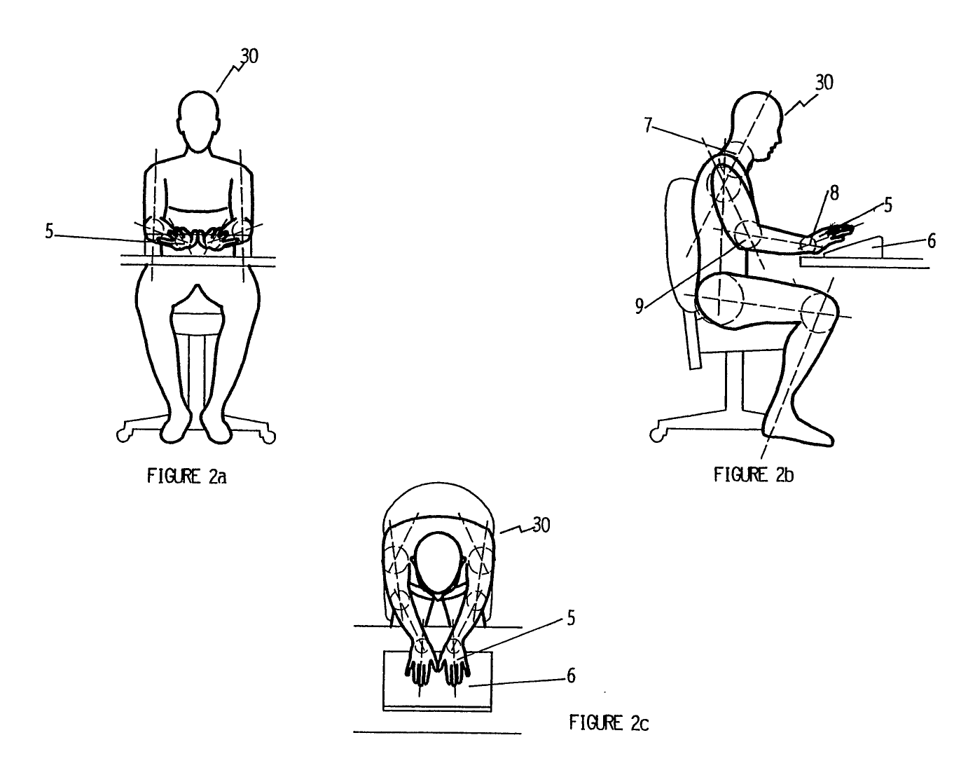

FIGS. 2a to 2c are front, side and plan views of a body's position when operating a conventional computer keyboard;

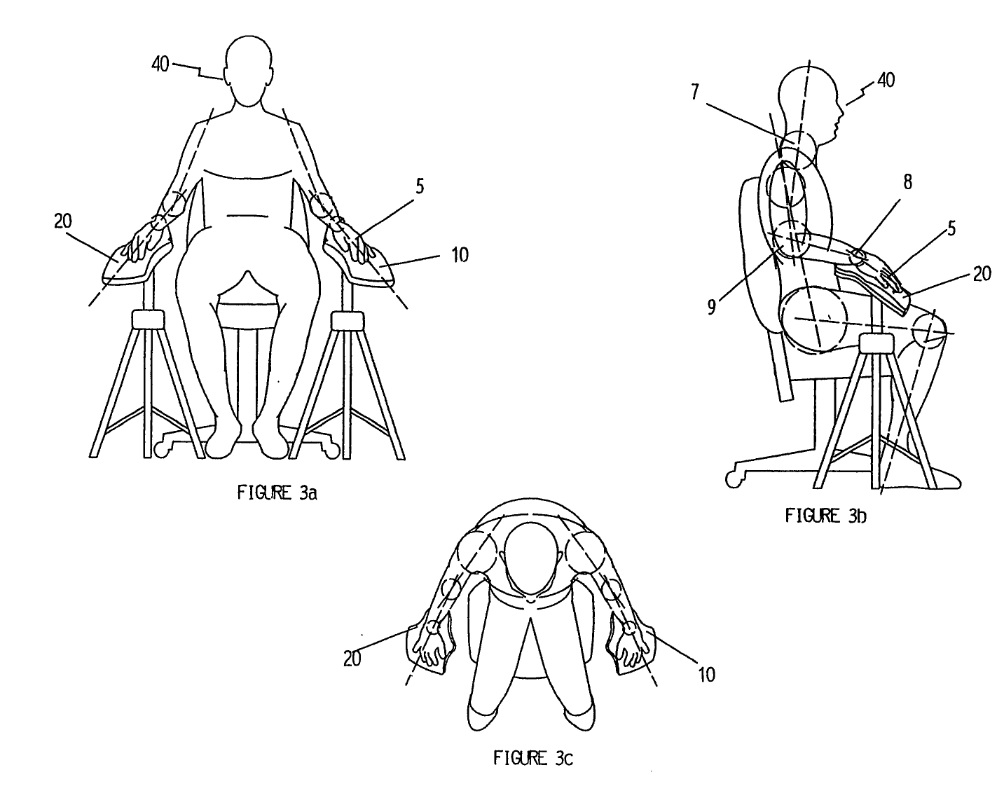

FIGS. 3a to 3c are front, side and plan views of a body's position when operating the computer keyboard according to the invention;

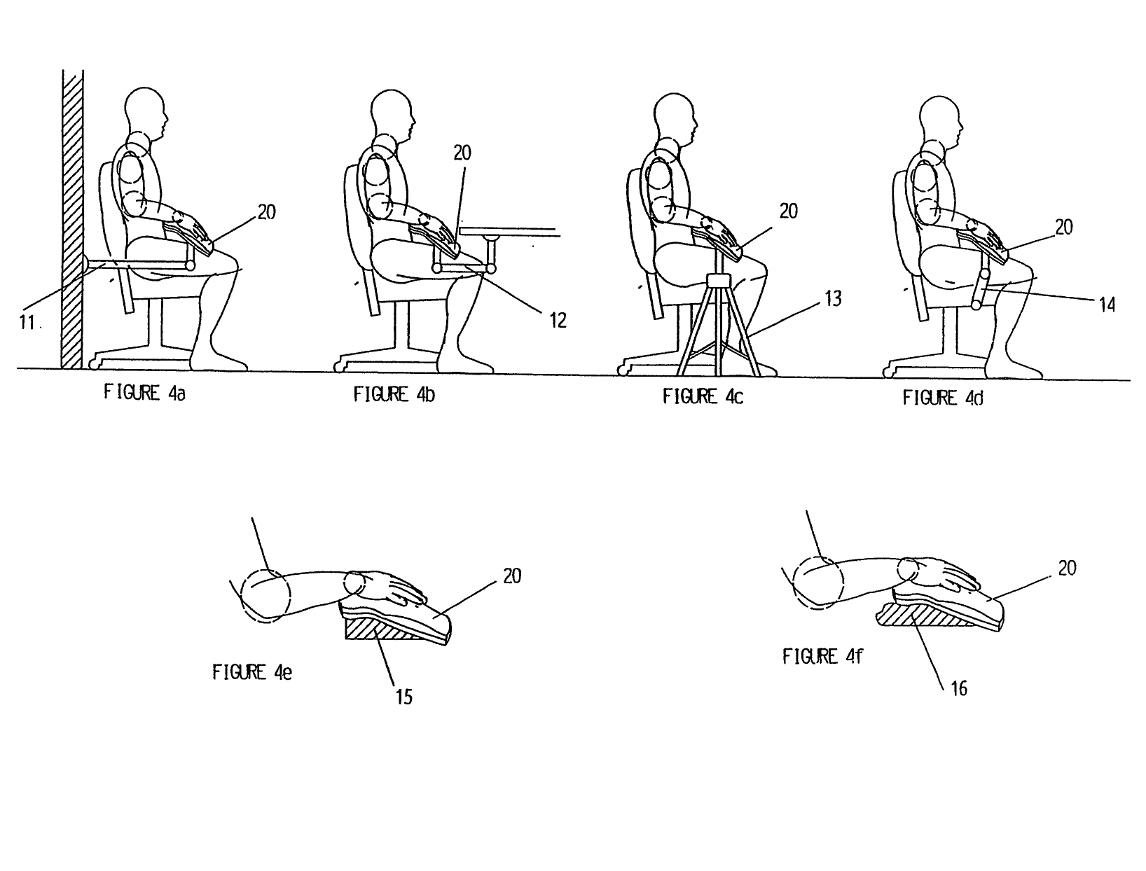

FIGS. 4a to 4f are side views of different fixing options of the computer keyboard of the invention;

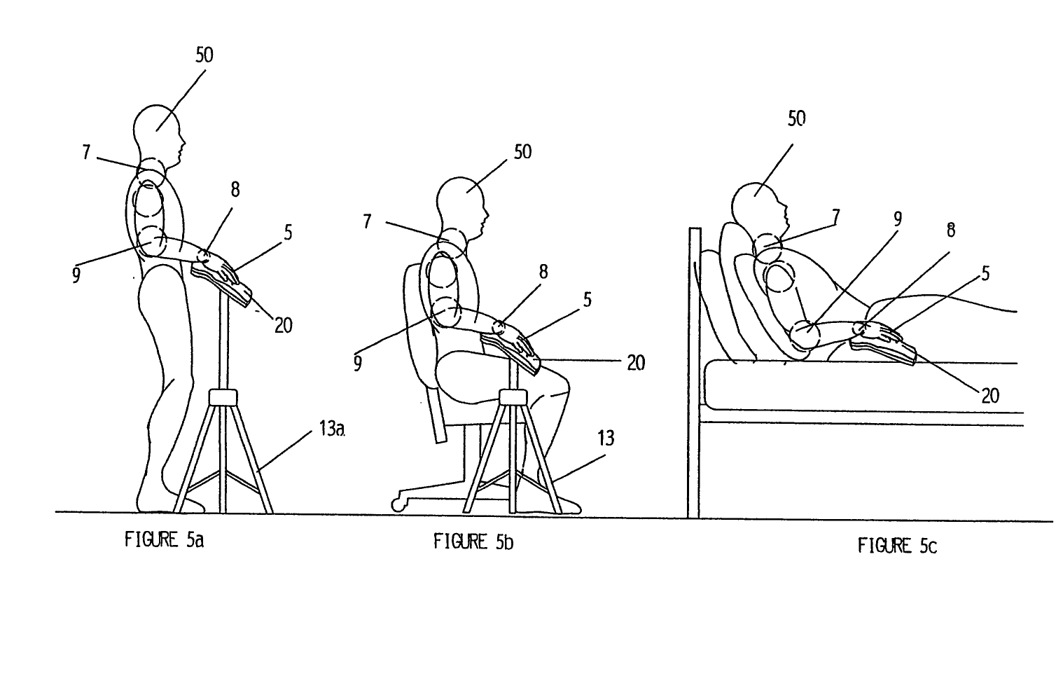

FIGS. 5a to 5c are side views of the computer keyboard of the invention when the user is standing, sitting and lying down respectively;

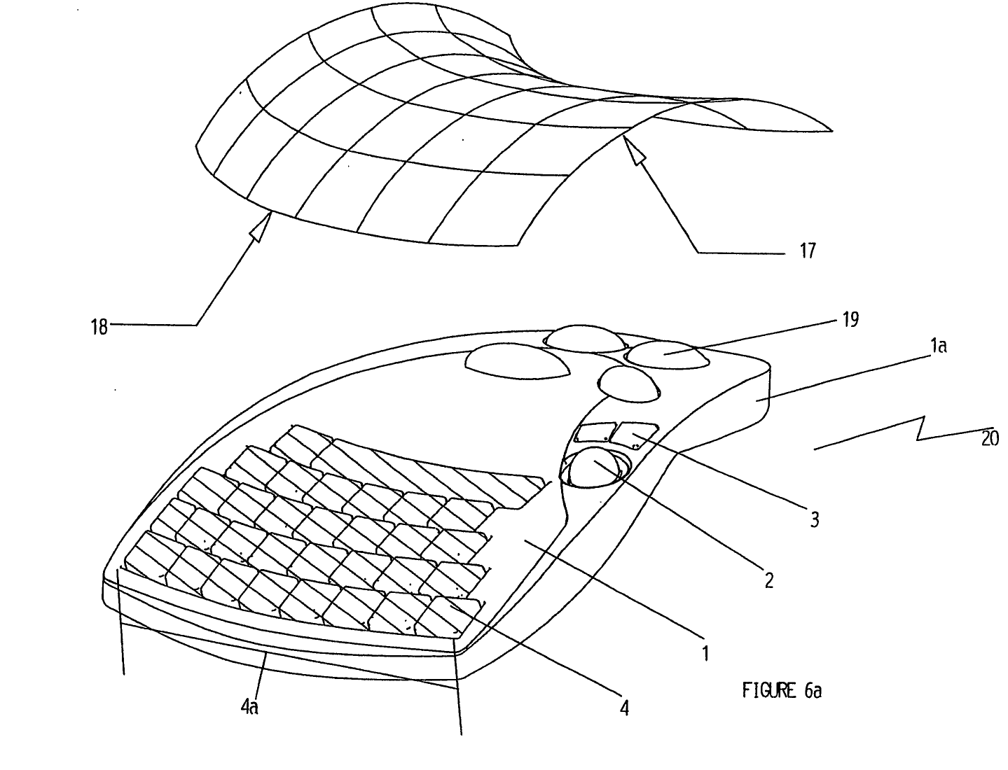

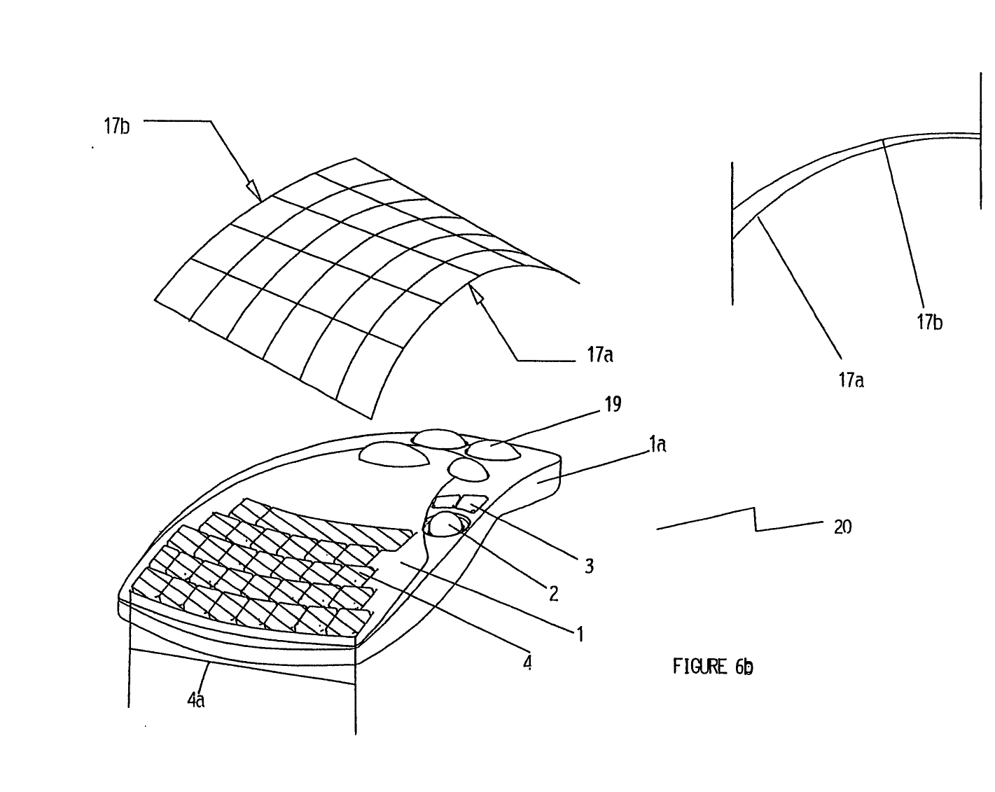

FIGS. 6a and 6b are perspective views of the right hand keypad of the invention, highlighting the different curves of key area of the keypad;

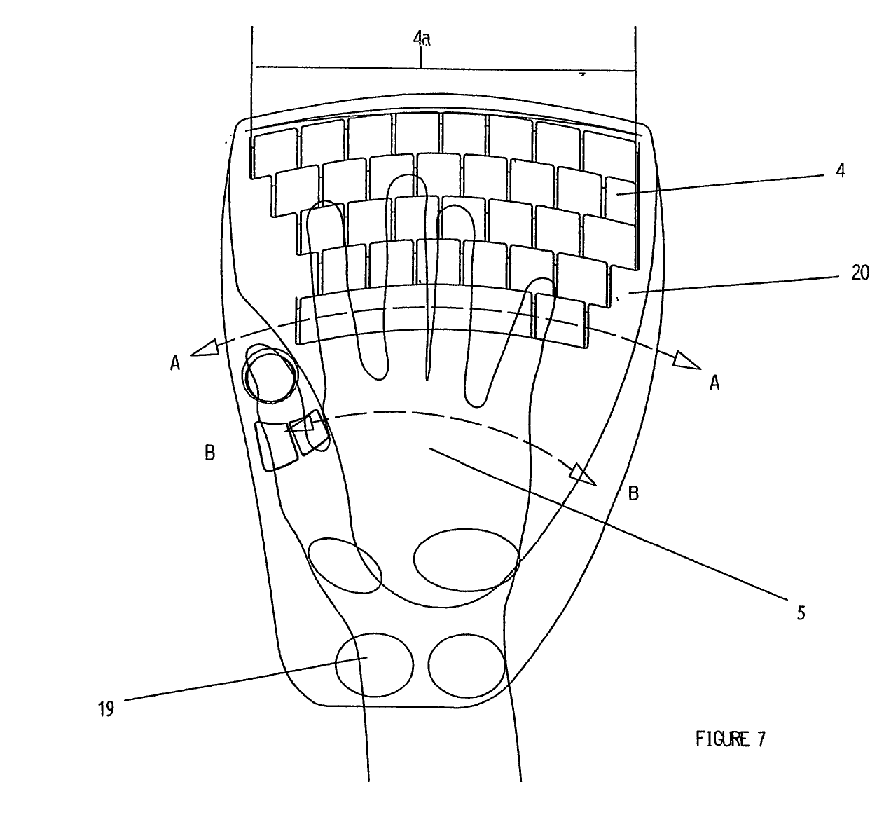

FIG. 7 is a plan view of the right hand keypad of the invention;

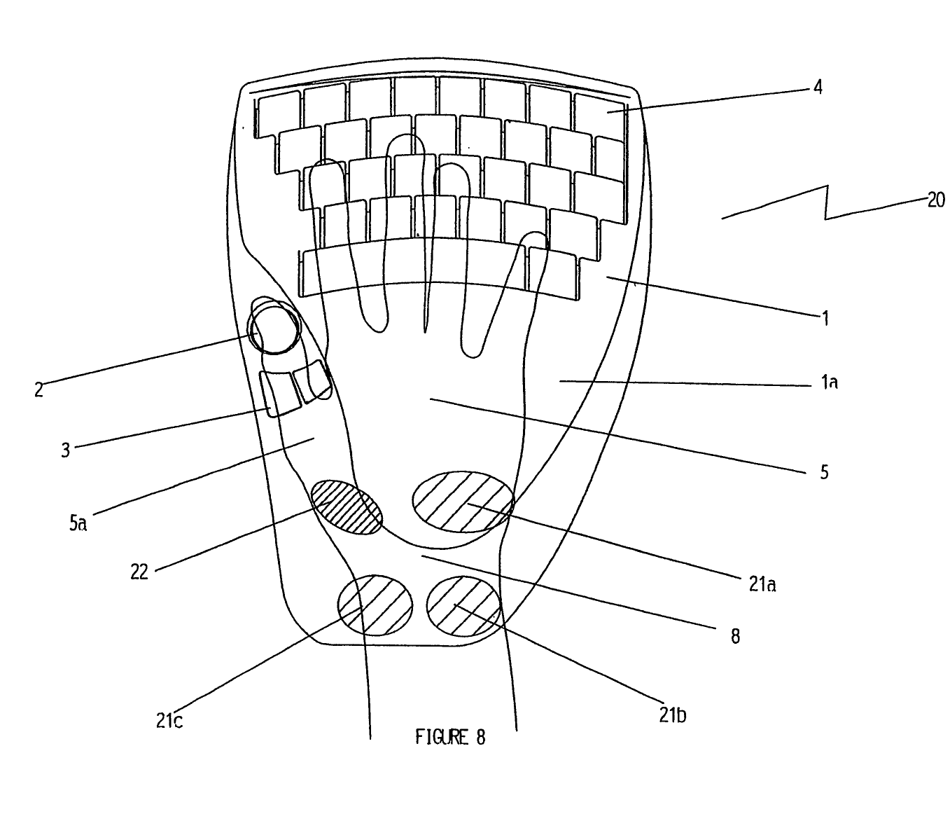

FIG. 8 is a plan view of the right hand keypad of FIG. 7 with highlighted cushioned areas;

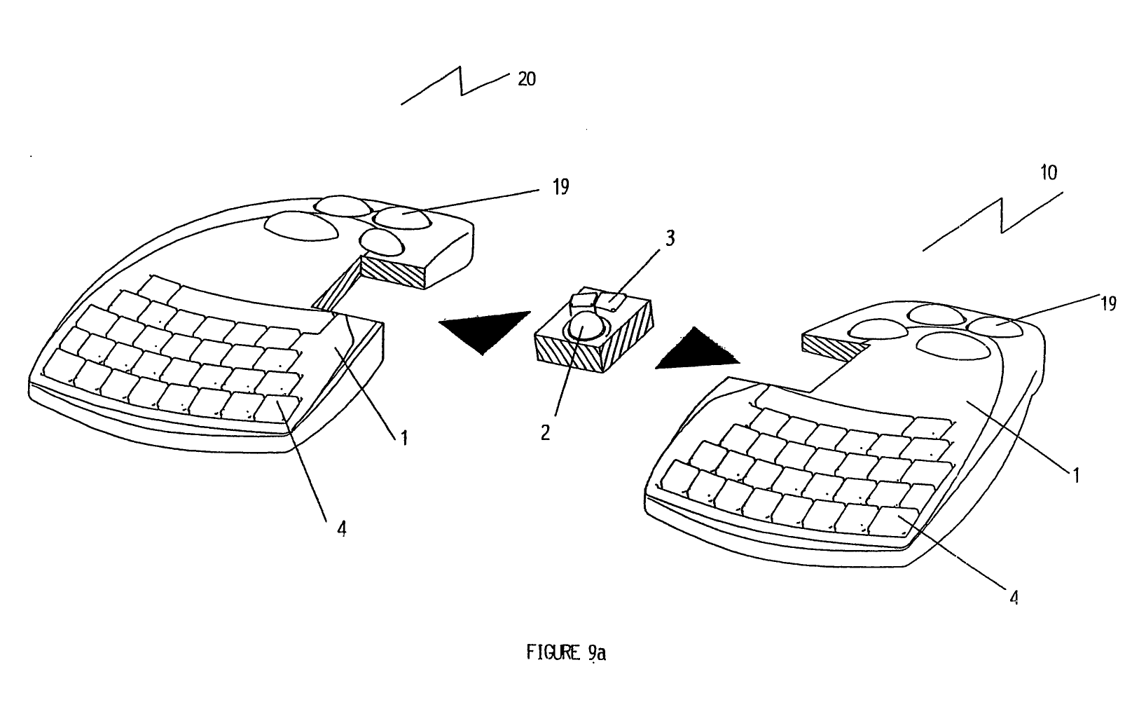

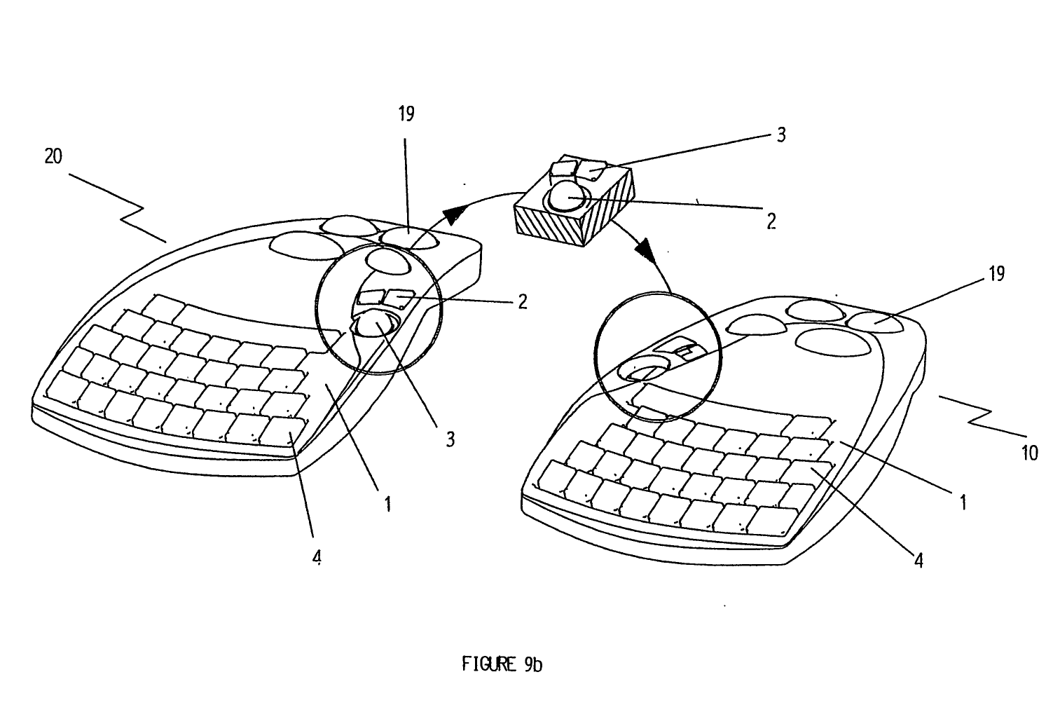

FIG. 9a is a perspective view of the right and left keypad with interchangeable roller ball feature;

FIG. 9b is a perspective view of the keypads of FIG. 9a with the roller ball feature in position on the keypads; and

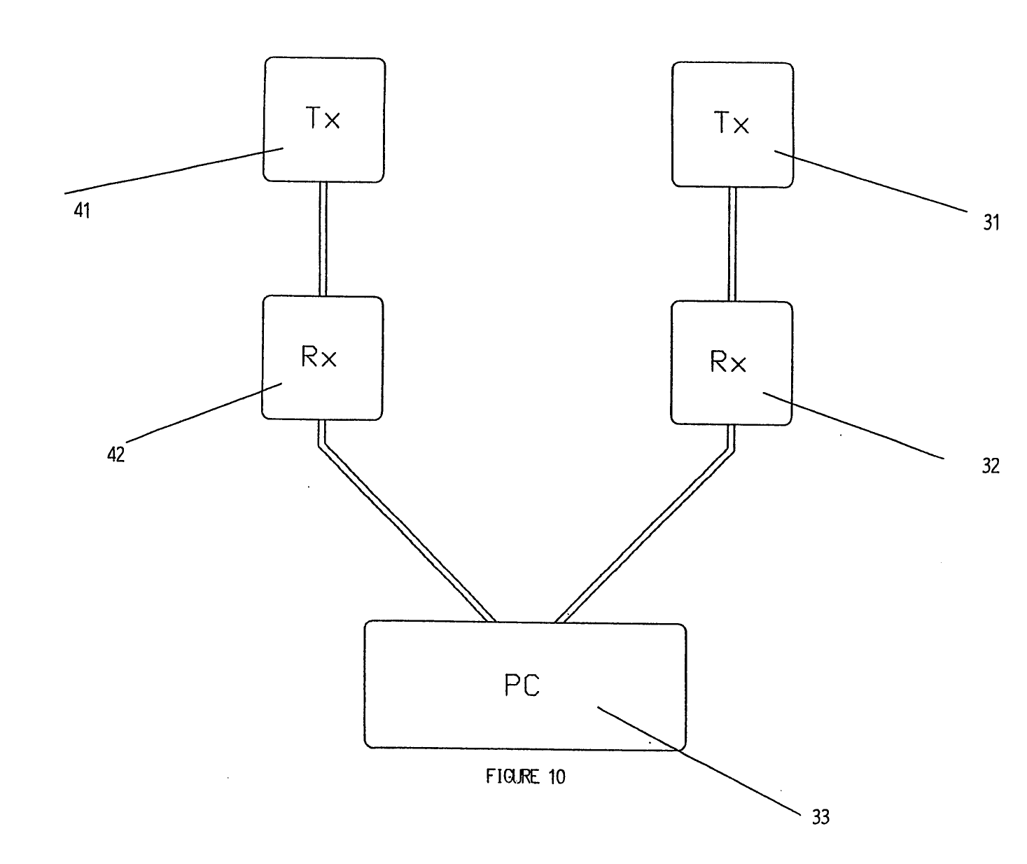

FIG. 10 is a flow diagram of the wireless application of the keyboard of the invention.

Referring to the drawings and initially to FIG. 1 a computer keyboard 100, is formed in two physically separate left and right keypads 10, 20 respectively. The two keypads 10 and 20 of the keyboard 100, the former for use by the left hand and the latter for use by the right hand comprise a key area 1, a wrist support area 1a and keys 4. Optionally one or both keypads 10 and 20 have a roller ball feature 2 where the roller ball feature 2 functions as a mouse. The left and right click buttons 3 normally found on a mouse are positioned beside the roller ball feature 2. In this figure the roller ball feature 2 is positioned on the right keypad 20, however the outline of where the feature would be positioned on the left keypad 10 is visible.

FIGS. 2a to 2c show the position of a body 30 when using a conventional keyboard 6. FIG. 2b in particular highlights the constrained angles of the neck joint 7, elbow joint 9, wrist joint 8 and hand 5. The users hands 5 are arched above the keys on the keyboard 6, causing the wrist joints 8 to bend upwards against the natural direction of bend in the wrist causing stress and strain to the carpel tunnel and meridian nerve in the wrist.

Conversely FIGS. 3a to 3c show the position of a body 40 when using the keypads 10 and 20 respectively of the invention. The users neck joint 7, elbow joint 9, wrist joint 8 and hand 5 are no longer in a constrained position. In particular the user assumes the correct joint positions, the elbow joint 9 adopts a natural relaxed position, the wrist joint 8 is not bent upwards and the hand 5 is not arched over the keys therefore the potential for nerve irritation is reduced.

FIGS. 4a to 4f are side views of the right hand keypad 20 in different fixing options available. FIG. 4a shows the keyboard 20 attached to a wall, using a wall mounted support 11. FIG. 4b shows the keyboard 20 attached to a desk 12 using a desk mounted support 12. FIGS. 4c and 4d respectively show two further options for the keypad 20, the keypad 20 can either be supported on a tripod arrangement 13 or can be mounted on the chair 14. FIGS. 4e and 4f show individual support for the keypad 20, where the keypad is resting on a flat surface. The individual support can either be a hard support 15 or soft support 16.

FIGS. 5a to 5c are side views of the right hand keypad 20 being operated by a user 50 in a standing position, a seated position and when lying down. The keypad 20 is supported by a tripod arrangement 13a and 13 in FIGS. 5a and 5b respectively. Whilst the keypad 20 is supported by an individual support (not shown) in FIG. 5c. It is noted that in all of these positions no strain is placed on the users neck joint, elbow joint 9, wrist joint 8 and the fingers of the hand 5 are not arched and uncomfortable.

FIGS. 6a and 6b are perspective views of the right hand keypad 20 comprising a key area 1 with keys 4, a wrist support area 1a with cushioned supports 19 and a roller ball 2 feature with right and left mouse buttons 3. The cushioned supports 19 are gel-filled pads that are capable of heating gently the area of the hand and wrist in contact with them when the keypad 20 is in use. The key area 1 of the keypad 20 has a curved surface 17 in addition the keys 4 occupy curved rows 4a, where the rows of keys 4a follow the natural curve of the knuckle joints on the hand thereby adopting an overall curve 18. In effect the rows of keys 4a exhibit a gentle fan effect which enables a user to allow their hand curve naturally over the keys, the user's fingers can then easily find and manipulate the keys. The curved surface 17 of the keypad 20 has two different radii 17a and 17b such that the keys 4 closest to the index and middle finger of the hand have a greater negative curve than the keys nearest the ring and little fingers. In effect this causes the keys nearest the ring and little fingers to be slightly raised providing easier access to these keys.

FIG. 7 is a plan view of the right hand keypad 20 highlighting the curve of the key rows A-A and the natural curve of the knuckle joints of the hand B-B.

FIG. 8 is a plan view of the right hand keypad 20 highlighting the position of the cushioned areas 19 comprising a four gel filled pads 21a to 21c and 22 respectively. The pads 21a to 21c and 22 respectively are arranged to support the thumb joint 5a of the hand 5 and stabilise wrist movement.

The pads 21a to 21c and 22 respectively are arranged in an overall square configuration. Three similarly sized pads 21a to 21c are used to stabilise the wrist 8. The pads 21a to 21c occupy three adjacent corners of the overall square shape. The fourth pad 22 occupies the fourth corner of the square shape and supports the thumb joint 5 in addition to carrying the weight of the hand 5. This arrangement provides support for the thumb joint 5a and hand 5 in addition to stability of the wrist 8. The wrist 8 is aligned and twisting of the wrist 8 is prevented. Furthermore this arrangement does not put any direct pressure on the carpel tunnel area of the wrist therefore reducing pressure on the meridian nerve and helping prevent RSI.

The gel filled pads 21a to 21c and 22 respectively provide a source of heat for the user's wrist 8 and thumb area. This warming action improves the overall molecular biology of the tissues in the wrist 8 and thumb area which further helps prevent irritation to the meridian nerve thus reducing RSI.

FIGS. 9a and 9b are perspective views of the right and left keypad 20 and 10 respectively highlighting the position of the roller ball feature 2 with left and right mouse buttons 3. FIG. 9a shows that the roller ball feature 2 is interchangeable between the right and left keypad 20 and 10 respectively, whilst FIG. 9b shows the roller ball feature 2 in position of both keypads 10 and 20. Alternatively, the rollerball device 2 is replaceable with a joystick unit (not shown) for operation by either a user's hand or thumb.

FIG. 10 is a flow diagram of the wireless application of the invention, where each keypad has an individual transmitter unit 31 and 41 respectively and receiver unit 32 and 42 respectively. Each transmitter unit independently transmits signals to the appropriate receiver unit, for example transmitter unit 31 transmits a signal to receiver unit 32 but not to receiver unit 42 and vice versa. The signal from each receiver unit 32 and 42 respectively is transmitted to a USB (not shown) where the signals are combined and then sent to the central processing unit (CPU) (not shown) of the computer (PC) 33.

It is of course understood that the description of these drawings in relation to the right hand keypad 20 is equally applicable to the left hand keypad 10.

The keypads 10 and 20 respectively are formed using environmentally friendly materials such as recycled plastics and/or biodegradable materials known to those persons skilled in the art. The size of each keypad 10 and 20 respectively is adjustable. For example, in order for a child to easily operate the keypads 10 and 20 respectively a small sized unit may be required, which enables a child to easily reach all the keys. However for an adult user a medium or large sized unit may be more appropriate.

It will of course be understood that the invention is not limited to the specific details described herein which are given by way of example only, and that various modifications and alterations are possible within the scope of the invention as defined in the appended claims.

1. An input device including at least one keypad, the keypad comprising a wrist support means and a key area, wherein the wrist support means of each keypad comprises a generally flat portion having a front and back portion and an upper and lower surface, the back portion being defined as the area of the wrist support means that is closest to a user's arm when in use and the front portion being defined as the area furthest from a user's arm when in use, wherein the wrist support means has a plurality of soft cushioned pads protruding from the upper surface of the flat portion, the key area comprises a curved unit having a front and back portion and an upper and lower surface, the back portion being defined as the area of the key area that is closest to a user's arm when in use and the front portion being defined as the area furthest from a user's arm when in use, wherein the back portion of the key area is contiguous to the front portion of the wrist support means, the key area having a negative convex curve, so that in use the upper surface of the front portion of the key area is positioned at a lower spatial position than the upper surface of the back portion of the key area, the key area having a plurality of keys positioned on the upper surface of the key area intermediate the front and back portions, and wherein the keys of the key area are arranged in a series of curved rows that are parallel to or concentric with the front and back portions of the key area, so that a central key in each row is further from the users wrist relative to at least one of the end keys in each row.

2. An input device as claimed in claim 1, wherein the wrist support means comprises a plurality of soft cushioned pads.

3. An input device as claimed in claim 2, wherein the soft cushioned pads of the wrist support means comprise a plurality of gel filled pads.

4. An input device as claimed in claim 2, wherein the soft cushioned pads of the wrist support means are arranged in a generally square configuration, wherein the square configuration is orientated such that in use one or more pads provide support for the thumb joint of the hand and a plurality of pads provide stabilisation for hand and wrist movement.

5. An input device as claimed in claim 4, wherein the plurality of cushioned pads pads provided for hand and wrist movement stabilisation occupy three adjacent corners of the overall square shape and one or more cushioned pads provided for support of the thumb joint occupies the fourth corner of the square shape.

6. An input device as claimed in claim 4, wherein the overall square configuration is orientated such that in use the support for the thumb joint is positioned under the thenar eminence of the hand, the hand movement stabiliser is positioned under the hypothenar eminence and the wrist movement stabilisers are positioned under the wrist such that the wrist joint is intermediate the thumb support and the wrist stabilisers.

7. An input device as claimed in claim 2, wherein the plurality of soft cushioned pads can be formed in a single moulding, wherein the moulding maintains the individual contact points for the user's wrist and/or hand and/or thumb when in use.

8. An input device as claimed in claim 7, wherein the single moulding is a soft contoured moulding

9. An input device as claimed in claims 3, wherein the gel filled pads include a source of heat for the user's wrist thereby warning the tendons of the wrist and hand.

10. An input device as claimed in claim 2, wherein the soft cushioned pads are formed from microcellular foam.

11. An input device as claimed in claim 1, wherein the keypad has a movable support means attached to the lower side which allows a user to manipulate the keypads in all directions to find the most comfortable position for the user to use the keypad.

12. An input device as claimed in claim 11, wherein the support means is manipulatable and lockable into a desired position.

13. An input device as claimed in claim 11, wherein the support means is adjustable in height to provide support to the keypad if the user wishes to stand up or sit down.

14. An input device as claimed in claim 11, wherein the support means is attachable to securing means to secure the keypad to an article of furniture such as a computer table or a chair or a wall.

15. An input device as claimed in claim 1, wherein the keys on the keypad are positioned in a series of curved rows, where the curve of each row follows the natural contour of the metacarpal phalangial joints of the hand.

16. An input device as claimed in claim 1, wherein the keys positioned at the end of each row are slightly raised to enable a user to access these keys with greater ease.

17. An input device as claimed in claim 1, wherein one or more keys on the keypad have dual functionality.

18. An input device as claimed in claim 1, wherein the input device comprises two keypads.

19. An input device as claimed in claim 18, wherein the first keypad is a left-hand keypad and the second keypad is a right-hand keypad.

20. An input device as claimed in claim 18, wherein the keys of each keypad are arranged using the QWERTY keyboard layout, where the alphanumeric keys of the keypad are split into left and right hand keypads along the natural split line of the QWERTY keyboard.

21. An input device as claimed in claim 18, wherein the functional keys and control keys are divided between the two keypads.

22. An input device as claimed in claim 18, wherein the keys of each keypad are arranged using the DVORAK keyboard arrangement where the alphanumeric keys of the keypad are split into left and right hand keypads along the natural split line of the DVORAK keyboard.

23. An input device as claimed in claim 1, wherein the keypad has an optional pointing device such as a roller ball feature which functions as a mouse.

24. An input device as claimed in claim 1, wherein the keypad has wireless functionality.

25. An input device as claimed in claim 1, wherein the keypad includes battery power means.

26. An input device as claimed in claim 1, wherein the keypad is adapted for use with specialist applications.

27. An input device as claimed in claim 26, wherein the keypad has specific commonly used programming command keys in addition to alphanumeric keys.

28. An input device as claimed in claim 28, wherein the keypad is adapted for use with computer games.

29. An input device as claimed in claim 28, wherein the keypad is adapted for use in specialist medical applications, for example where a user has limited and or restricted movement of the hand and fingers.

30. An input device substantially as herein described with reference to and as shown in the accompanying drawings.

31. An input device as claimed in claim 3, wherein the soft cushioned pads of the wrist support means are arranged in a generally square configuration, wherein the square configuration is orientated such that in use one or more pads provide support for the thumb joint of the hand and a plurality of pads provide stabilisation for hand and wrist movement.

32. An input device as claimed in claim 5, wherein the overall square configuration is orientated such that in use the support for the thumb joint is positioned under the thenar eminence of the hand, the hand movement stabiliser is positioned under the hypothenar eminence and the wrist movement stabilisers are positioned under the wrist such that the wrist joint is intermediate the thumb support and the wrist stabilisers.

33. An input device as claimed in claim 4, wherein the soft cushioned pads are formed from microcellular foam.

34. An input device as claimed in claim 5, wherein the soft cushioned pads are formed from microcellular foam.

35. An input device as claimed in claim 6, wherein the soft cushioned pads are formed from microcellular foam.

36. An input device as claimed in claim 12, wherein the support means is adjustable in height to provide support to the keypad if the user wishes to stand up or sit down.

37. An input device as claimed in claim 12, wherein the support means is attachable to securing means to secure the keypad to an article of furniture such as a computer table or a chair or a wall.

38. An input device as claimed in claim 13, wherein the support means is attachable to securing means to secure the keypad to an article of furniture such as a computer table or a chair or a wall.

39. An input device as claimed in claim 19, wherein the keys of each keypad are arranged using the QWERTY keyboard layout, where the alphanumeric keys of the keypad are split into left and right hand keypads along the natural split line of the QWERTY keyboard.

40. An input device as claimed in claim 19, wherein the functional keys and control keys are divided between the two keypads.

41. An input device as claimed in claim 20, wherein the functional keys and control keys are divided between the two keypads.

42. An input device as claimed in claim 19, wherein the keys of each keypad are arranged using the DVORAK keyboard arrangement where the alphanumeric keys of the keypad are split into left and right hand keypads along the natural split line of the DVORAK keyboard.
